(19) United States
(12) Patent Application Publication
(10) Pub. No.: US 2025/0038911 A1
(43) Pub. Date: Jan. 30, 2025

(54) METHOD AND APPARATUS FOR FREQUENCY DENSITY DETERMINATION, AND STORAGE MEDIUM

(71) Applicant: SPREADTRUM COMMUNICATIONS (SHANGHAI) CO., LTD., Shanghai (CN)

(72) Inventor: Meng ZHANG, Shanghai (CN)

(21) Appl. No.: 18/841,550

(22) PCT Filed: Feb. 16, 2023
(86) PCT No.: PCT/CN2023/076568

§ 371 Date: Aug. 26, 2024

(30) Foreign Application Priority Data
Feb. 28, 2022 (CN) 202210191950.1

(51) Int. Cl. H04L 5/00

(52) U.S. Cl. CPC H04L 5/0048; H04L 5/0092

(57) ABSTRACT

A method and an apparatus for frequency density determination, and a storage medium are disclosed. The method includes the following. A first number of resource blocks (RBs) is determined based on scheduled resources for a first physical channel, where the scheduled resources for the first physical channel cover multiple subbands. Frequency density of a phase tracking reference signal (PT-RS) in a first subband is determined based on the first number of RBs. The first physical channel is a physical downlink shared channel (PDSCH), and the first subband is any downlink subband covered by the scheduled resources for the first physical channel. Alternatively, the first physical channel is a physical uplink shared channel (PUSCH), and the first subband is any uplink subband covered by the scheduled resources for the first physical channel.

### CROSS-REFERENCE TO RELATED APPLICATION(S)

This application is a National Stage of International Application No. PCT/CN2023/076568, field Feb. 16, 2023, which claims priority to Chinese Patent Application No. 202210191950.1 filed Feb. 28, 2022, the entire disclosure of which are hereby incorporated by reference.

### TECHNICAL FIELD

This disclosure relates to the field of communication, and in particular to a method and an apparatus for frequency density determination, and a non-transitory computer-readable storage medium.

### BACKGROUND

Phase noise refers to a random change in a phase of a system output signal caused by a radio frequency (RF) device under the action of various noises (e.g., random white noise, flicker noise). The phase noise causes a large number of bit errors at a receiving end, which limits the use of a high order modulation, thereby seriously affecting the system capacity.

Relatively speaking, phase noise has a small impact on a lower frequency band, while the phase noise has a substantially increased impact on a high frequency band (millimeter wave) due to various reasons such as a significant increase in times of frequency multiplication of a reference clock source, a process level and power consumption of a device, etc. In order to cooperate with the phase noise in the high frequency band, a phase tracking reference signal (PT-RS) is introduced into the 5G new radio (NR), and the receiving end can estimate and compensate the phase noise based on the PT-RS.

The receiver needs to determine time-frequency resources for the PT-RS based on frequency density of the PT-RS and time density of the PT-RS. In order to adapt to the flexible and changeable uplink and downlink service scenarios, full-duplex communication may be supported in the future. In full-duplex communication scenarios, there are multiple subbands in the same time unit, and types of different subbands can be uplink or downlink. The PT-RS can be carried in the physical downlink shared channel (PDSCH)/physical uplink shared channel (PUSCH). In the full-duplex communication scenarios, when a scheduled bandwidth for PDSCH/PUSCH covers multiple subbands, how to determine the frequency density of the PT-RS is an urgent problem to be solved at present.

### SUMMARY

In a first aspect, a method for frequency density determination is provided in the present disclosure. The method includes the following. A first number of resource blocks (RBs) is determined based on scheduled resources for a first physical channel, where the scheduled resources for the first physical channel cover multiple subbands. Frequency density of a PT-RS in a first subband is determined based on the first number of RBs. The first physical channel is a PDSCH, and the first subband is any downlink subband covered by the scheduled resources for the first physical channel. Alternatively, the first physical channel is a PUSCH, and the first subband is any uplink subband covered by the scheduled resources for the first physical channel.

In a second aspect, an apparatus for frequency density determination is provided in implementations of the present disclosure. The apparatus for frequency density determination includes a memory and a processor. The memory is configured to store a computer program, and the computer program includes program instructions. The processor is configured to invoke the program instructions to perform the method in the first aspect or in any possible implementation thereof.

In a third aspect, a non-transitory computer-readable storage medium is provided in the present disclosure. The non-transitory computer-readable storage medium is configured to store computer-readable instructions which, when executed on a communication apparatus, cause the communication apparatus to perform the method in the first aspect or in any possible implementation thereof.

### BRIEF DESCRIPTION OF THE DRAWINGS

In order to describe more clearly technical solutions of implementations of the present disclosure, the following will give a brief introduction to accompanying drawings used for describing implementations. Apparently, the accompanying drawings described below are some implementations of the present disclosure. Based on these drawings, those of ordinary skill in the art can also obtain other drawings without creative effort.

FIG. 1 is a schematic diagram illustrating full duplex provided in implementations of the present disclosure.

FIG. 2 is a schematic flowchart of a method for frequency density determination provided in implementations of the present disclosure.

FIG. 3 is a schematic structural diagram of an apparatus for frequency density determination provided in implementations of the present disclosure.

FIG. 4 is a schematic structural diagram of a module device provided in other implementations of the present disclosure.

### DETAILED DESCRIPTION

Technical solutions of implementations of the present disclosure will be described clearly and completely below with reference to the accompanying drawings in the implementations of the present disclosure. Apparently, implementations described herein are some implementations, rather than all implementations, of the present disclosure. Based on the implementations of the present disclosure, all other implementations obtained by those of ordinary skill in the art without creative effort shall fall within the protection scope of the present disclosure.

The terms used in implementations of the present disclosure are merely intended for describing the implementations, rather than limiting implementations of the present disclosure. For example, the singular form “a/an”, “one”, “said”, “above”, “the”, and “this” used in implementations of the present disclosure and the appended claims are also intended to include multiple forms, unless specified otherwise in the context. It can also be understood that the term “and/or” used in the present disclosure refers to and includes any or all possible combinations of one or more of the items listed.

It can be noted that the terms “first”, “second”, “third”, etc., in the specification of implementations, claims of the present disclosure, and the accompanying drawings are used to distinguish similar objects, and are not necessarily used to describe a particular sequence or order. It should be understood that, the terms thus used may be interchangeable where appropriate, so that the implementations of the present disclosure described herein, for example, can be implemented in a sequence other than those illustrated or described herein. In addition, the terms “include”, “comprise”, and “have” as well as variations thereof are intended to cover a non-exclusive inclusion. For example, a process, method, system, product, or server including a series of steps or units is not limited to the listed steps or units, and instead, it can optionally include other steps or units that are not listed or other steps or units inherent to the process, method, product, or device.

In order to facilitate the understanding of the solutions provided in implementations of the present disclosure, some of the terms involved in implementations of the present disclosure are first elaborated below.

### 1. Terminal Device

A terminal device includes a device that provides voice and/or data connectivity to a user, e.g., a terminal device is a device with wireless transceiver functionality that can be deployed on land, which includes indoor or outdoor, handheld, wearable, or in-vehicle. The terminal device can also be deployed on water (such as ships, etc.). The terminal device can also be deployed in the air (such as airplanes, balloons, satellites, etc.). The terminal device can be a mobile phone, a vehicle, a roadside unit (RSU), a pad, a computer with wireless transceiver functions, a virtual reality (VR) terminal device, an augmented reality (AR) terminal device, a wireless terminal in industrial control, in-vehicle terminal device, a wireless terminal in self-driving, a wireless terminal in remote medicine, a wireless terminal in smart grid, a wireless terminal in transportation safety, a wireless terminal in smart city, a wireless terminal in smart home, a wearable terminal device, etc. Implementations of the present disclosure do not limit the application scenarios. The terminal device can also be referred to as a terminal, a user equipment (UE), an access terminal device, an in-vehicle terminal, an industrial control terminal, a UE unit, a UE station, a mobile station, a mobile platform, a remote station, a remote terminal device, a mobile device, a UE terminal device, a terminal device, a wireless communication device, a UE agent, a UE apparatus, etc. The terminal can also be fixed or mobile. In implementations of the present disclosure, an apparatus for implementing the functions of the terminal device can be the terminal device or an apparatus capable of supporting the terminal device to implement its functions, such as a chip system or a combined device or component that can implement the functions of the terminal device, which can be installed in the terminal device.

### 2. Network Device

A network device is a node or a device that connects the terminal device to a wireless network. A network side (i.e., network device) involved in the present disclosure includes, but is not limited to, a base station, an evolved NodeB (eNodeB), a transmission reception point (TRP), a next-generation NodeB (gNB) in a 5G mobile communication system, a gNB in a sixth generation (6G) mobile communication system, a base station in a future mobile communication system, an access node in a WiFi system, etc. The base station involved in the present disclosure can also be a module or unit that implements some of the functions of the base station, such as a central unit (CU) or a distributed unit (DU). Herein, the CU implements functions of a radio resource control (RRC) layer and functions of a packet data convergence protocol (PDCP) layer of the base station, and can also implement functions of a service data adaptation protocol (SDAP). The DU implements functions of a radio link control (RLC) layer, functions of a media access control (MAC) layer of the base station, and functions of some or all of physical (PHY) layers. For specific descriptions of the above protocol layers, reference can be made to related technical specifications of the 3rd generation partnership project (3GPP). The base station in the present disclosure can be a macro base station, a micro base station or an indoor station, a relay node, a donor node, etc. In implementations of the present disclosure, an apparatus for implementing the function of the network device can be the network device or an apparatus capable of supporting the network device to implement its function, such as a chip system or a combined device or component that can implement the functions of an access network equipment, which can be installed in the network device. Implementations of the present disclosure do not limit specific technology and specific device forms used by the network device.

### 3. Full-Duplex Communication

Current wireless communication systems, such as a wireless fidelity (WiFi) and a long-term evolution (LTE), are based on half-duplex transmission, i.e., a same device is not allowed to perform transmission and reception operations on the same carrier or the same time-frequency resources simultaneously. Recently, the 3rd Generation Partnership Project (3GPP) has proposed that a terminal device working in a half-duplex mode is scheduled jointly, so that a network device (such as a base station) can perform transmission and reception simultaneously, and full duplex is implemented on the network device side, i.e., the network device performs transmission and reception on different subbands of the same carrier simultaneously. The full duplex on the network device side can be referred to as “full duplex”, “subband full duplex”, “X division duplex (XDD)”, etc.

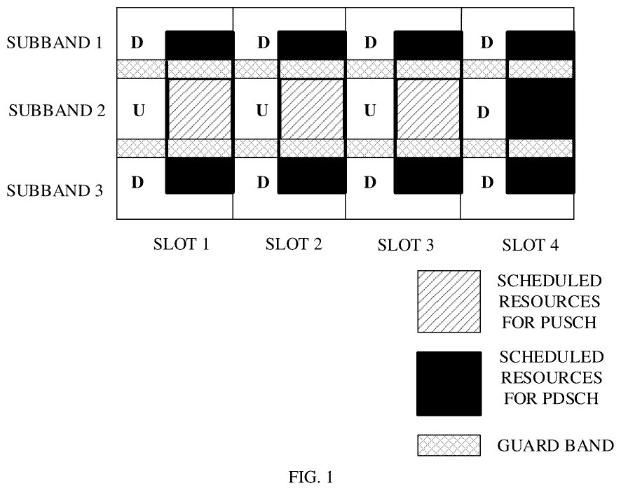

For example, as illustrated in FIG. 1, in slot 1 to slot 4, the network device configures scheduled resources for a physical downlink shared channel (PDSCH) for terminal device 1, and the scheduled resources for the PDSCH are continuous in frequency domain in each slot. In slot 1 to slot 4, all the scheduled resources for the PDSCH cover subband 1 to subband 3, i.e., all the scheduled resources for the PDSCH overlap with subband 1 to subband 3. In order to implement full-duplex communication, in slot 1 to slot 3, the network device configures scheduled resources for a physical uplink shared channel (PUSCH) for terminal device 2, and the scheduled resources for the PUSCH are continuous in the frequency domain in each slot. In slot 1 to slot 3, all the scheduled resources for the PUSCH cover subband 2, i.e., the scheduled resources for the PUSCH overlap with subband 2.

There is also a guard band between two subbands. The guard band includes one or more resource blocks (RBs). The guard band is used for avoiding interference between two neighboring subbands. For example, as illustrated in FIG. 1, there is a guard band between subband 1 and subband 2, and a guard band between subband 2 and subband 3. The guard band is not used for transmitting PDSCH or PUSCH.

The network device can pre-configure a transmission type of each subband for terminal device 1 and terminal device 2. For example, the network device can indicate terminal device 1 and terminal device 2 that in slot 1 to slot 3, subband 1 and subband 3 are used for downlink transmission, and subband 2 is used for uplink transmission; and in slot 4, subband 1 to subband 3 are all used for downlink transmission. In this way, in slot 1 to slot 3, even if the scheduled resources for the PDSCH cover subband 1 to subband 3, terminal device 1 receives the PDSCH only on resources overlapping between the scheduled resources for the PDSCH and subband 1 as well as between the scheduled resources for the PDSCH and subband 3. In slot 4, terminal device 1 receives the PDSCH on resources overlapping between the scheduled resources for the PDSCH and subband 1, between the scheduled resources for the PDSCH and subband 2, and between the scheduled resources for the PDSCH and subband 3. Similarly, in slot 1 to slot 3, terminal device 2 transmits the PDSCH only on resources overlapping between the scheduled resources for the PUSCH and subband 2.

### 4. Phase Tracking Reference Signal (PT-RS)

A PT-RS is used for estimating and compensating phase noise. The PT-RS can be carried in a PDSCH/PUSCH.

In existing standards, a way for determining frequency density of the PT-RS is illustrated in Table 1. As illustrated in Table 1, the frequency density of the PT-RS is determined based on a scheduled frequency resource bandwidth for the PDSCH/PUSCH. An interval value N_{RBi}, where i=0,1, is configured by a higher-layer signaling. N_{RB} in the existing standards is a total number of RBs in the scheduled frequency resource bandwidth for the PDSCH/PUSCH.

TABLE 1
table for determining the frequency density of the PT-RS

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

In full-duplex communication scenarios, when a scheduled bandwidth for the PDSCH/PUSCH covers multiple subbands, how to determine the frequency density of the PT-RS is an urgent problem to be solved at present. For example, as illustrated in FIG. 1, in slot 1 to slot 4, all the PDSCH cover subband 1 to subband 3. In this case, how to determine frequency density of a PT-RS in each subband is an urgent problem to be solved at present.

In order to determine the frequency density of the PT-RS when the scheduled bandwidth for the PDSCH/PUSCH covers multiple subbands in the full-duplex communication scenarios, a method and an apparatus for frequency density determination, a chip, and a module device are provided in the present disclosure. The following will elaborate on the method and the apparatus for frequency density determination, the chip, and the module device provided in the present disclosure.

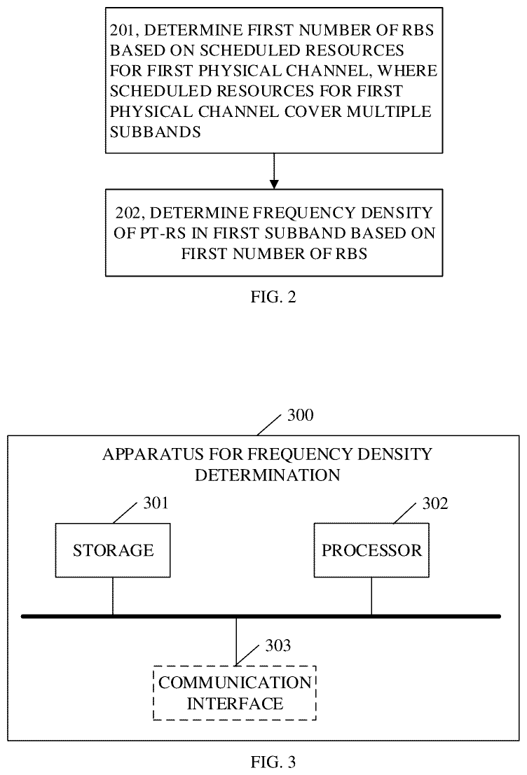

FIG. 2 is a schematic flowchart of a method for frequency density determination provided in implementations of the present disclosure. As illustrated in FIG. 2, the method for frequency density determination includes operations at S201 to S202 as follows. The method as illustrated in FIG. 2 can be implemented by a terminal device or a network device. Alternatively, the method as illustrated in FIG. 2 can be implemented by a chip in the terminal device or a chip in the network device.

201, a first number of RBs is determined based on scheduled resources for a first physical channel, where the scheduled resources for the first physical channel cover multiple subbands.

202, frequency density of a PT-RS in a first subband is determined based on the first number of RBs.

The first physical channel is a PDSCH, and the first subband is any downlink subband covered by the scheduled resources for the first physical channel. Alternatively, the first physical channel is a PUSCH, and the first subband is any uplink subband covered by the scheduled resources for the first physical channel.

The downlink subband refers to a subband used for downlink transmission, and the uplink subband refers to a subband used for uplink transmission.

Optionally, the frequency density of the PT-RS in the first subband can be determined according to Table 1 and the first number of RBs, where N_{RB} is the first number of RBs.

Optionally, the operations at S201 and S202 can be performed in one slot. Optionally, the first number of RBs corresponding to different slots can be determined respectively, and the first number of RBs corresponding to different slots can be the same or different. Then, the frequency density of the PT-RS in the first subband and in a slot is determined based on the first number of RBs corresponding to the slot.

As an example, the first physical channel is the PDSCH. As illustrated in FIG. 1, in slot 1 to slot 4, all scheduled resources for the PDSCH cover subband 1 to subband 3, i.e., the scheduled resources for the PDSCH overlap with subband 1 to subband 3. In slot 1 to slot 3, subband 1 and subband 3 are downlink subbands, i.e., subband 1 and subband 3 are used for downlink transmission; and subband 2 is an uplink subband, i.e., subband 2 is used for uplink transmission. In slot 4, subband 1 to subband 3 are downlink subbands. Therefore, in slot 1 to slot 3, the PDSCH is transmitted on a part overlapping between the scheduled resources for the PDSCH and subband 1 as well as between the scheduled resources for the PDSCH and subband 3. In slot 4, the PDSCH is transmitted on a part overlapping between the scheduled resources for the PDSCH and subband 1, between the scheduled resources for the PDSCH and subband 2, and between the scheduled resources for the PDSCH and subband 3.

In slot 1, a first number 1 of RBs can be determined based on scheduled resources for a PDSCH in slot 1, and frequency density of a PT-RS in subband 1 or subband 3 can be determined based on the first number 1 of RBs. For slot 2 and slot 3, reference can be made to slot 1, which is not repeated herein.

In slot 4, a first number 4 of RBs can be determined based on scheduled resources for a PDSCH in slot 4, and frequency density of a PT-RS in subband 1, subband 2, or subband 3 can be determined based on the first number 4 of RBs.

When the first physical channel is the PUSCH, the frequency density of the PT-RS in the first subband can be determined in the same way, which is not repeated herein.

In a possible implementation, the first number of RBs is the number of RBs overlapping between the subbands covered by the scheduled resources for the first physical channel and the scheduled resources for the first physical channel.

In other words, when the first number of RBs is calculated, RBs overlapping between the scheduled resources for the first physical channel and guard bands can be excluded, i.e., RBs in the guard bands are not calculated into the first number of RBs. In this way, the frequency density of the PT-RS in the first subband can be determined more accurately.

When the first number of RBs is the number of RBs overlapping between the subbands covered by the scheduled resources for the first physical channel and the scheduled resources for the first physical channel, several implementations of the first number of RBs will be described as follows.

Implementation 1: the first number of RBs is specifically the number of RBs overlapping between all subbands covered by the scheduled resources for the first physical channel and the scheduled resources for the first physical channel.

In Implementation 1, the first physical channel can be the PDSCH or the PUSCH.

As an example, as illustrated in FIG. 1, the first physical channel is the PDSCH. In slot 1, the scheduled resources for the PDSCH cover subband 1 to subband 3. Assuming that in slot 1, the number of RBs overlapping between the scheduled resources for the PDSCH and subband 1 is 2, the number of RBs overlapping between the scheduled resources for the PDSCH and subband 2 is 3, and the number of RBs overlapping between the scheduled resources for the PDSCH and subband 3 is 2, then the first number of RBs corresponding to slot 1 can be determined as 7, i.e., 2+2+3. The frequency density of the PT-RS in slot 1 and in subband 1 or subband 3 can be determined based on the first number of RBs. For determining the first number of RBs corresponding to other slots, reference can be made to slot 1, which is not repeated herein. When the first physical channel is the PUSCH, the first number of RBs can be determined in the same way, which is not repeated herein.

In Implementation 1, frequency density of a PT-RS in each subband used for transmitting the first physical channel is the same in one slot by default. In this way, for the same slot, only frequency density of a PT-RS in one subband used for transmitting the first physical channel needs to be calculated, thereby reducing the complexity of the calculation.

Implementation 2: the first physical channel is the PDSCH, and the first number of RBs is specifically the number of RBs overlapping between all downlink subbands covered by the scheduled resources for the first physical channel and the scheduled resources for the first physical channel.

As an example, as illustrated in FIG. 1, in slot 1, the scheduled resources for the PDSCH cover downlink subband 1 and downlink subband 3. Assuming that in slot 1, the number of RBs overlapping between the scheduled resources for the PDSCH and subband 1 is 2, and the number of RBs overlapping between the scheduled resources for the PDSCH and subband 3 is 2, then the first number of RBs corresponding to slot 1 can be determined as 4, i.e., 2+2. The frequency density of the PT-RS in slot 1 and in subband 1 or subband 3 can be determined based on the first number of RBs. For determining the first number of RBs corresponding to slot 2 and slot 3, reference can be made to slot 1, which is not repeated herein.

In slot 4, the scheduled resources for the PDSCH cover downlink subband 1, downlink subband 2, and downlink subband 3. Assuming that in slot 4, the number of RBs overlapping between the scheduled resources for the PDSCH and subband 1 is 2, the number of RBs overlapping between the scheduled resources for the PDSCH and subband 2 is 3, and the number of RBs overlapping between the scheduled resources for the PDSCH and subband 3 is 2, then the first number of RBs corresponding to slot 4 can be determined as 7, i.e., 2+2+3. The frequency density of the PT-RS in slot 4 and in subband 1, subband 2, or subband 3 can be determined based on the first number of RBs.

In Implementation 2, the frequency density of the PT-RS in each subband used for transmitting the first physical channel is the same in one slot by default. In this way, for the same slot, only the frequency density of the PT-RS in one subband used for transmitting the first physical channel needs to be calculated, thereby reducing the complexity of the calculation. Additionally, RBs overlapping between uplink subbands and the scheduled resources for the first physical channel are not calculated into the first number of RBs. Therefore, the frequency density of the PT-RS in the first subband can be determined more accurately based on the first number of RBs in Implementation 2.

Implementation 3: the first physical channel is the PUSCH, and the first number of RBs is specifically the number of RBs overlapping between all uplink subbands covered by the scheduled resources for the first physical channel and the scheduled resources for the first physical channel. For implementations of Implementation 3, reference can be made to Implementation 2, which is not repeated herein.

In Implementation 3, the frequency density of the PT-RS in each subband used for transmitting the first physical channel is the same in one slot by default. In this way, for the same slot, only the frequency density of the PT-RS in one subband used for transmitting the first physical channel needs to be calculated, thereby reducing the complexity of the calculation. Additionally, RBs overlapping between downlink subbands and the scheduled resources for the first physical channel are not calculated into the first number of RBs. Therefore, the frequency density of the PT-RS in the first subband can be determined more accurately based on the first number of RBs in Implementation 3.

Implementation 4: the first number of RBs is specifically the number of RBs overlapping between the first subband and the scheduled resources for the first physical channel. In Implementation 4, the first physical channel can be the PDSCH or the PUSCH.

As an example, the first physical channel is the PDSCH. As illustrated in FIG. 1, assuming that the frequency density of the PT-RS in slot 1 and in subband 1 needs to be determined, then the frequency density of the PT-RS in slot 1 and in subband 1 needs to be determined based on the number of RBs overlapping between the scheduled resources for the PDSCH and subband 1 corresponding to slot 1.

Assuming that the frequency density of the PT-RSs in slot 1 and in subband 3 needs to be determined, then the frequency density of the PT-RS in slot 1 and in subband 3 needs to be determined based on the number of RBs overlapping between the scheduled resources for the PDSCHs and subband 3 corresponding to slot 1.

In actual applications, the frequency density of the PT-RS in different subbands can be different. In Implementation 4, the first number of RBs is determined only based on the number of RBs overlapping between the first subband and the scheduled resources for the first physical channel, and RBs overlapping between other subbands and the scheduled resources for the first physical channel are not calculated into the first number of RBs. Therefore, the frequency density of the PT-RS in the first subband can be determined more accurately based on the first number of RBs in Implementation 4.

In another possible implementation, the first number of RBs can also be a total number of RBs included in the scheduled resources for the first physical channel. In other words, in this possible implementation, RBs overlapping between the scheduled resources for the first physical channel and the guard bands are also calculated into the first number of RBs.

In another possible implementation, the first number of RBs can also be a total number of all RBs included in the scheduled resources for the first physical channel minus a total number of RBs overlapping between the scheduled resources for the first physical channel and all guard bands. In other words, in this possible implementation, the RBs overlapping between the scheduled resources for the first physical channel and the guard bands are not calculated into the first number of RBs.

In another possible implementation, if the first physical channel is the PDSCH, the first number of RBs can also be a total number of RBs in the scheduled resources for the first physical channel other than RBs in the uplink subbands. In other words, in this possible implementation, the RBs overlapping between the scheduled resources for the first physical channel and the guard bands are also calculated into the first number of RBs, but RBs overlapping between the scheduled resources for the first physical channel and the uplink subbands are not calculated into the first number of RBs.

In another possible implementation, if the first physical channel is the PUSCH, the first number of RBs can also be a total number of RBs in the scheduled resources for the first physical channel other than RBs in the downlink subbands. In other words, in this possible implementation, the RBs overlapping between the scheduled resources for the first physical channel and the guard bands are also calculated into the first number of RBs, but RBs overlapping between the scheduled resources for the first physical channel and the downlink subbands are not calculated into the first number of RBs.

An apparatus for frequency density determination is further provided in implementations of the present disclosure. The apparatus for frequency density determination can be a terminal device or an apparatus with the functions of the terminal device (e.g., a chip) or a network device or an apparatus with the functions of the network device (e.g., a chip). Specifically, the apparatus for frequency density determination can include a determining unit. The determining unit is configured to determine a first number of RBs based on scheduled resources for a first physical channel, where the scheduled resources for the first physical channel cover multiple subbands. The determining unit is further configured to determine frequency density of a PT-RS in a first subband based on the first number of RBs. The first physical channel is a PDSCH, and the first subband is any downlink subband covered by the scheduled resources for the first physical channel. Alternatively, the first physical channel is a PUSCH, and the first subband is any uplink subband covered by the scheduled resources for the first physical channel.

In a possible implementation, the first number of RBs is the number of RBs overlapping between the subbands covered by the scheduled resources for the first physical channel and the scheduled resources for the first physical channel.

In a possible implementation, the first number of RBs is the number of RBs overlapping between the subbands covered by the scheduled resources for the first physical channel and the scheduled resources for the first physical channel as follows. The first number of RBs is the number of RBs overlapping between all subbands covered by the scheduled resources for the first physical channel and the scheduled resources for the first physical channel.

In a possible implementation, the first physical channel is the PDSCH. The first number of RBs is the number of RBs overlapping between the subbands covered by the scheduled resources for the first physical channel and the scheduled resources for the first physical channel as follows. The first number of RBs is the number of RBs overlapping between all downlink subbands covered by the scheduled resources for the first physical channel and the scheduled resources for the first physical channel.

In a possible implementation, the first physical channel is the PUSCH. The first number of RBs is the number of RBs overlapping between the subbands covered by the scheduled resources for the first physical channel and the scheduled resources for the first physical channel as follows. The first number of RBs is the number of RBs overlapping between all uplink subbands covered by the scheduled resources for the first physical channel and the scheduled resources for the first physical channel.

In a possible implementation, the first number of RBs is the number of RBs overlapping between the subbands covered by the scheduled resources for the first physical channel and the scheduled resources for the first physical channel as follows. The first number of RBs is the number of RBs overlapping between the first subband and the scheduled resources for the first physical channel.

In a possible implementation, the first number of RBs is a total number of RBs included in the scheduled resources for the first physical channel.

A chip is further provided in implementations of the present disclosure. The chip is configured to perform related operations implemented by a terminal device or a network device in the method implementations. The chip includes a processor and a communication interface. The processor is configured to cause the chip to operate as follows. A first number of RBs is determined based on scheduled resources for a first physical channel, where the scheduled resources for the first physical channel cover multiple subbands. Frequency density of a PT-RS in a first subband is determined based on the first number of RBs. The first physical channel is a PDSCH, and the first subband is any downlink subband covered by the scheduled resources for the first physical channel. Alternatively, the first physical channel is a PUSCH, and the first subband is any uplink subband covered by the scheduled resources for the first physical channel.

In a possible implementation, the first number of RBs is the number of RBs overlapping between the subbands covered by the scheduled resources for the first physical channel and the scheduled resources for the first physical channel.

In a possible implementation, the first number of RBs is the number of RBs overlapping between the subbands covered by the scheduled resources for the first physical channel and the scheduled resources for the first physical channel as follows. The first number of RBs is the number of RBs overlapping between all subbands covered by the scheduled resources for the first physical channel and the scheduled resources for the first physical channel.

In a possible implementation, the first physical channel is the PDSCH. The first number of RBs is the number of RBs overlapping between the subbands covered by the scheduled resources for the first physical channel and the scheduled resources for the first physical channel as follows. The first number of RBs is the number of RBs overlapping between all downlink subbands covered by the scheduled resources for the first physical channel and the scheduled resources for the first physical channel.

In a possible implementation, the first physical channel is the PUSCH. The first number of RBs is the number of RBs overlapping between the subbands covered by the scheduled resources for the first physical channel and the scheduled resources for the first physical channel as follows. The first number of RBs is the number of RBs overlapping between all uplink subbands covered by the scheduled resources for the first physical channel and the scheduled resources for the first physical channel.

In a possible implementation, the first number of RBs is the number of RBs overlapping between the subbands covered by the scheduled resources for the first physical channel and the scheduled resources for the first physical channel as follows. The first number of RBs is the number of RBs overlapping between the first subband and the scheduled resources for the first physical channel.

In a possible implementation, the first number of RBs is a total number of RBs included in the scheduled resources for the first physical channel.

Reference can be made to FIG. 3, which is a schematic structural diagram of an apparatus for frequency density determination provided in implementations of the present disclosure. The apparatus for frequency density determination can be a terminal device or a network device. An apparatus 300 for frequency density determination can include a memory 301 and a processor 302. Optionally, the apparatus 300 for frequency density determination further includes a communication interface 303. The memory 301, the processor 302, and the communication interface 303 are connected to each other via one or more communication buses. The communication interface 303 is controlled by the processor 302 for transmitting and receiving information.

The memory 301 can include a read-only memory (ROM) and a random access memory (RAM) and provide instructions and data to the processor 302. A portion of the memory 301 can also include a non-volatile RAM.

The communication interface 303 is configured to receive or transmit data.

The processor 302 can be a central processing unit (CPU), other general-purpose processors, a digital signal processor (DSP), an application-specific integrated circuit (ASIC), field-programmable gate array (FPGA), other programmable logic devices, discrete gates or transistor logic devices, discrete hardware components, etc. The general-purpose processor can be a microprocessor, and optionally, the processor 302 can also be any conventional processor or the like. The memory 301 is configured to store program instructions. The processor 302 is configured to invoke the program instructions stored in memory 301. The processor 302 is configured to invoke the program instructions stored in the memory 301 to cause the apparatus 300 for frequency density determination to perform the method implemented by a terminal device or a network device in the method implementations.

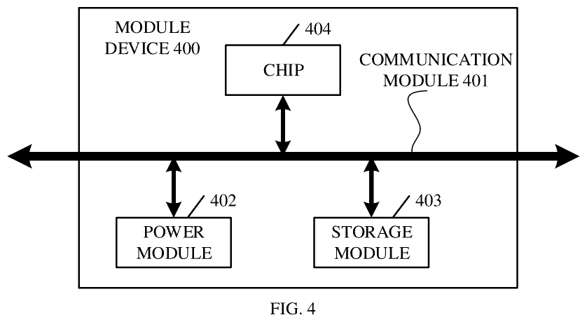

As illustrated in FIG. 4, FIG. 4 is a schematic structural diagram of a module device provided in implementations of the present disclosure. A module device 400 can perform related operations implemented by a terminal device or a network device in the method implementations. The module device 400 includes a communication module 401, a power module 402, a storage module 403, and a chip 404.

The power module 402 is configured to power the module device. The storage module 403 is configured to store data and instructions. The communication module 401 is configured to perform internal communication within the module device or perform communication between the module device and an external device. The chip 404 is configured to perform the method implemented by the terminal device or the network device in the method implementations.

It can be noted that for contents not mentioned and specific implementations of various operations in implementations corresponding to FIG. 3 or FIG. 4, reference can be made to implementations illustrated in FIG. 1 and the foregoing, which is not repeated herein.

A computer-readable storage medium is further provided in implementations of the present disclosure. The computer-readable storage medium is configured to store instructions which, when executed on a processor, cause the processor to implement the operations of the method in the method implementations.

A computer program product is further provided in implementations of the present disclosure. When the computer program product is executed on a processor, the processor can implement the operations of the method in the method implementations.

For each apparatus and product described in the implementations, each module/unit included can be a software module/unit, a hardware module/unit, or can be partially a software module/unit and partially a hardware module/unit. For example, for each apparatus and product applied to or integrated into the chip, each module/unit included can be implemented by hardware such as circuits, or at least part of modules/units can be implemented by software programs that run on a processor integrated into the chip, and the rest (if any) of modules/units can be implemented by hardware such as circuits. For each apparatus and product applied to or integrated into the chip module, each module/unit included can be implemented by hardware such as a circuit, and different modules/units can be located in a same component (such as a chip, a circuit module, etc.) or different components of the chip module. Alternatively, at least part of modules/units can be implemented by software programs that run on the processor integrated into the chip module, and the rest (if any) of modules/units can be implemented by hardware such as circuits. For each apparatus and product applied to or integrated into the terminal, each module/unit included can be implemented by hardware such as circuits, and different modules/units can be located in a same component (e.g., a chip, a circuit module, etc.) or different components in the terminal, or at least part of modules/units can be implemented by software programs that run on the processor integrated into the terminal, and the rest (if any) of modules/units can be implemented by hardware such as circuits.

It can be noted that, for the sake of simplicity, the foregoing method implementations are described as a series of action combinations. However, it will be appreciated by those skilled in the art that implementations are not limited by the sequence of actions described. According to implementations, some steps or operations can be performed in other orders or simultaneously. Besides, it will be appreciated by those skilled in the art that the implementations described in the specification are exemplary implementations, and the actions and modules involved are not necessarily essential to the present disclosure.

Mutual reference can be made to the descriptions of various implementations of the present disclosure, and the description of each implementation has its own emphasis. For the parts not described in detail in one implementation, reference can be made to related descriptions in other implementations. For the sake of convenience and simplicity, for functions of the apparatuses and devices provided in implementations of the present disclosure and operations performed by the apparatuses and devices, reference can be made to related descriptions of the method implementations of the present disclosure. The method implementations and the apparatus implementations can also be mutually referred to, combined, or cited.

Finally, it can be noted that the foregoing implementations are merely intended for describing the technical solutions of the present disclosure, but not for limiting the present disclosure. Although the present disclosure is described in detail with reference to the foregoing implementations, those of ordinary skill in the art can understand that they can still make modifications to the technical solutions described in the foregoing implementations or make equivalent replacements to some or all technical features thereof, without departing from the scope of the technical solutions of implementations of the present disclosure.

1. A method for frequency density determination, comprising:
determining a first number of resource blocks (RBs) based on scheduled resources for a first physical channel, wherein the scheduled resources for the first physical channel cover a plurality of subbands; and
frequency density determination of a phase tracking reference signal (PT-RS) in a first subband based on the first number of RBs; wherein
the first physical channel is a physical downlink shared channel (PDSCH), and the first subband is any downlink subband covered by the scheduled resources for the first physical channel; or the first physical channel is a physical uplink shared channel (PUSCH), and the first subband is any uplink subband covered by the scheduled resources for the first physical channel.

2. The method of claim 1, wherein the first number of RBs is the number of RBs overlapping between the subbands covered by the scheduled resources for the first physical channel and the scheduled resources for the first physical channel.

3. The method of claim 2, wherein the first number of RBs being the number of RBs overlapping between the subbands covered by the scheduled resources for the first physical channel and the scheduled resources for the first physical channel comprises:
the first number of RBs is the number of RBs overlapping between all subbands covered by the scheduled resources for the first physical channel and the scheduled resources for the first physical channel.

4. The method of claim 2, wherein
the first physical channel is the PDSCH; and
the first number of RBs being the number of RBs overlapping between the subbands covered by the scheduled resources for the first physical channel and the scheduled resources for the first physical channel comprises:
the first number of RBs is the number of RBs overlapping between all downlink subbands covered by the scheduled resources for the first physical channel and the scheduled resources for the first physical channel.

5. The method of claim 2, wherein
the first physical channel is the PUSCH; and
the first number of RBs being the number of RBs overlapping between the subbands covered by the scheduled resources for the first physical channel and the scheduled resources for the first physical channel comprises:
the first number of RBs is the number of RBs overlapping between all uplink subbands covered by the scheduled resources for the first physical channel and the scheduled resources for the first physical channel.

6. The method of claim 2, wherein the first number of RBs being the number of RBs overlapping between the subbands covered by the scheduled resources for the first physical channel and the scheduled resources for the first physical channel comprises:
the first number of RBs is the number of RBs overlapping between the first subband and the scheduled resources for the first physical channel.

7. The method of claim 1, wherein the first number of RBs is a total number of RBs comprised in the scheduled resources for the first physical channel.

8. The method of claim 1, wherein the first number of RBs is a total number of all RBs comprised in the scheduled resources for the first physical channel minus a total number of RBs overlapping between the scheduled resources for the first physical channel and all guard bands.

9-18. (canceled)

19. An apparatus for frequency density determination, comprising:
a memory configured to store a computer program, the computer program comprising program instructions; and
a processor configured to invoke the program instructions to cause the apparatus for frequency density determination to perform:
determining a first number of resource blocks (RBs) based on scheduled resources for a first physical channel, wherein the scheduled resources for the first physical channel cover a plurality of subbands; and
frequency density determination of a phase tracking reference signal (PT-RS) in a first subband based on the first number of RBs; wherein
the first physical channel is a physical downlink shared channel (PDSCH), and the first subband is any downlink subband covered by the scheduled resources for the first physical channel; or the first physical channel is a physical uplink shared channel (PUSCH), and the first subband is any uplink subband covered by the scheduled resources for the first physical channel.

20. A non-transitory computer-readable storage medium configured to store computer-readable instructions which, when executed on a communication apparatus, cause the communication apparatus to perform:
determining a first number of resource blocks (RBs) based on scheduled resources for a first physical channel, wherein the scheduled resources for the first physical channel cover a plurality of subbands; and
frequency density determination of a phase tracking reference signal (PT-RS) in a first subband based on the first number of RBs; wherein
the first physical channel is a physical downlink shared channel (PDSCH), and the first subband is any downlink subband covered by the scheduled resources for the first physical channel; or the first physical channel is a physical uplink shared channel (PUSCH), and the first subband is any uplink subband covered by the scheduled resources for the first physical channel.

21. (canceled)

22. The apparatus of claim 19, wherein the first number of RBs is the number of RBs overlapping between the subbands covered by the scheduled resources for the first physical channel and the scheduled resources for the first physical channel.

23. The apparatus of claim 22, wherein the first number of RBs being the number of RBs overlapping between the subbands covered by the scheduled resources for the first physical channel and the scheduled resources for the first physical channel comprises:
the first number of RBs is the number of RBs overlapping between all subbands covered by the scheduled resources for the first physical channel and the scheduled resources for the first physical channel.

24. The apparatus of claim 22, wherein
the first physical channel is the PDSCH; and
the first number of RBs being the number of RBs overlapping between the subbands covered by the scheduled resources for the first physical channel and the scheduled resources for the first physical channel comprises:
the first number of RBs is the number of RBs overlapping between all downlink subbands covered by the scheduled resources for the first physical channel and the scheduled resources for the first physical channel.

25. The apparatus of claim 22, wherein
the first physical channel is the PUSCH; and
the first number of RBs being the number of RBs overlapping between the subbands covered by the scheduled resources for the first physical channel and the scheduled resources for the first physical channel comprises:
the first number of RBs is the number of RBs overlapping between all uplink subbands covered by the scheduled resources for the first physical channel and the scheduled resources for the first physical channel.

26. The apparatus of claim 22, wherein the first number of RBs being the number of RBs overlapping between the subbands covered by the scheduled resources for the first physical channel and the scheduled resources for the first physical channel comprises:
the first number of RBs is the number of RBs overlapping between the first subband and the scheduled resources for the first physical channel.

27. The apparatus of claim 19, wherein the first number of RBs is a total number of RBs comprised in the scheduled resources for the first physical channel.

28. The apparatus of claim 19, wherein the first number of RBs is a total number of all RBs comprised in the scheduled resources for the first physical channel minus a total number of RBs overlapping between the scheduled resources for the first physical channel and all guard bands.

29. The non-transitory computer-readable storage medium of claim 20, wherein the first number of RBs is the number of RBs overlapping between the subbands covered by the scheduled resources for the first physical channel and the scheduled resources for the first physical channel.

30. The non-transitory computer-readable storage medium of claim 29, wherein the first number of RBs being the number of RBs overlapping between the subbands covered by the scheduled resources for the first physical channel and the scheduled resources for the first physical channel comprises:
the first number of RBs is the number of RBs overlapping between all subbands covered by the scheduled resources for the first physical channel and the scheduled resources for the first physical channel.

31. The non-transitory computer-readable storage medium of claim 29, wherein
the first physical channel is the PDSCH; and
the first number of RBs being the number of RBs overlapping between the subbands covered by the scheduled resources for the first physical channel and the scheduled resources for the first physical channel comprises:
the first number of RBs is the number of RBs overlapping between all downlink subbands covered by the scheduled resources for the first physical channel and the scheduled resources for the first physical channel.
